(19) United States
(12) Patent Application Publication
(10) Pub. No.: US 2025/0262738 A1
(43) Pub. Date: Aug. 21, 2025

(54) ATTACHMENT FOR POWERED HAMMER

(71) Applicant: MILWAUKEE ELECTRIC TOOL CORPORATION, Brookfield, WI (US)

(72) Inventors: Ryan T. Bumgarner, Milwaukee, WI (US); Travis J. DuMez, Port Washington, WI (US); Katherine J. Haim, Waukesha, WI (US)

(21) Appl. No.: 19/052,384

(22) Filed: Feb. 13, 2025

Related U.S. Application Data
(60) Provisional application No. 63/554,260, filed on Feb. 16, 2024.

(51) Int. Cl. B25D 17/00

(52) U.S. Cl. CPC B25D 17/005

(57) ABSTRACT

An attachment configured for use with a powered hammer to drive a rod into the ground includes a body and an impact portion defining an impact axis. The impact portion includes a bore configured to receive a drive shank that is coupled to the powered hammer. The impact portion is configured to receive repeated impacts from the powered hammer. The attachment also includes a driving portion in which the rod is receivable. The driving portion includes a side load driving portion defining a side load driving axis. The side load driving axis is non-parallel to the impact axis.

### CROSS-REFERENCE TO RELATED APPLICATIONS

This application claims priority to U.S. Provisional Patent Application No. 63/554,260, filed on Feb. 16, 2024, the entire contents of which are incorporated by reference herein.

### FIELD OF THE INVENTION

The present invention relates to powered hammers, and more particularly to attachments for use with powered hammers.

### BACKGROUND OF THE INVENTION

Long metal ground rods are inserted into the ground to electrically ground various circuits. For example, a ground rod may be used near transmission line towers to electrically ground the transmission lines or near residential construction to electrically ground a residential circuit. To install, the rods are typically positioned vertically on the ground, and an operator subsequently applies downward impacts upon a top end of the rod to drive it into the ground.

### SUMMARY OF THE INVENTION

The present invention provides, in one aspect, an attachment configured for use with a powered hammer to drive a rod into the ground. The attachment includes a body and an impact portion defining an impact axis. The impact portion includes a bore configured to receive a drive shank that is coupled to the powered hammer. The impact portion is configured to receive repeated impacts from the powered hammer. The attachment also includes a driving portion in which the rod is receivable. The driving portion includes a side load driving portion defining a side load driving axis. The side load driving axis is non-parallel to the impact axis.

The present invention provides, in another aspect, an attachment configured for use with a powered hammer to drive a rod into the ground. The attachment includes a body and an impact portion defining an impact axis. The impact portion includes a bore configured to receive a drive shank that is coupled to the powered hammer. The impact portion is configured to receive repeated impacts from the powered hammer. The attachment also includes a driving portion in which the rod is receivable. The driving portion is configured to engage the rod and transmit a driving force due to impacts from the powered hammer to the rod. The attachment further includes a retention device adjacent the bore of the impact portion. The retention device includes a locking mechanism configured to secure the drive shank in the bore. The locking mechanism allows axial movement of the drive shank within the bore along the impact axis.

The present invention provides, in another aspect, an attachment configured for use with a powered hammer to drive a rod into the ground. The attachment includes a body defining an aperture and an impact portion defining an impact axis. The impact portion is configured to receive repeated impacts from a drive shank of the powered hammer. The attachment also includes a driving portion including a one-way collet positioned at least partially within an aperture of the body and configured to transmit a driving force generated by the impacts from the powered hammer to the rod. The one-way collet defines a driving axis that is angled relative to the impact axis. The driving portion also includes an end cap coupled to the body and extending over a portion of the aperture. The driving portion further includes a biasing member disposed between the collet and the end cap.

Other aspects of the invention will become apparent by consideration of the detailed description and accompanying drawings.

### BRIEF DESCRIPTION OF THE DRAWINGS

FIG. 1A is a top perspective view of an attachment for use with a powered hammer according to one embodiment of the present disclosure.

FIG. 1B is a bottom perspective view of the attachment of FIG. 1A.

FIG. 2 is a side view of the attachment of FIG. 1A.

FIG. 3 is a cross-sectional view of the attachment of FIG. 1A, taken along section line 3-3 in FIG. 1A.

FIG. 4A is a side view of an existing attachment in use.

FIG. 4B is a side view of the attachment of FIG. 1A in use.

FIG. 5 is a cross-sectional view of an attachment according to another embodiment.

FIG. 6 is a cross-sectional view of an attachment according to another embodiment and in a first position.

FIG. 7 is a cross-sectional view of the attachment of FIG. 6 in a second position.

FIG. 8 is a cross-sectional view of an attachment according to another embodiment and in a first position.

FIG. 9 is a cross-sectional view of the attachment of FIG. 8 in an intermediate position.

FIG. 10 is a cross-sectional view of the attachment of FIG. 8 in a second position.

FIG. 11 is a bottom perspective view of another attachment.

FIG. 12 is a cross-sectional view of the attachment of FIG. 11, taken along section line 12-12 of FIG. 11.

FIG. 13 is a side view of an end cap for use with the attachment of FIG. 11.

FIG. 14 is a perspective view of the end cap of FIG. 13.

FIG. 15 is a side view of another end cap for use with the attachment of FIG. 11.

FIG. 16 is a perspective view of the end cap of FIG. 15.

FIG. 17 is a bottom perspective view of another attachment.

FIG. 18 is a cross-sectional view of the attachment of FIG. 17, taken along section line 18-18 of FIG. 17.

FIG. 19 is an enlarged cross-sectional view of a portion of the attachment shown in FIG. 18.

FIG. 20 is perspective of an end cap for use with the attachment of FIG. 17.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting.

### DETAILED DESCRIPTION

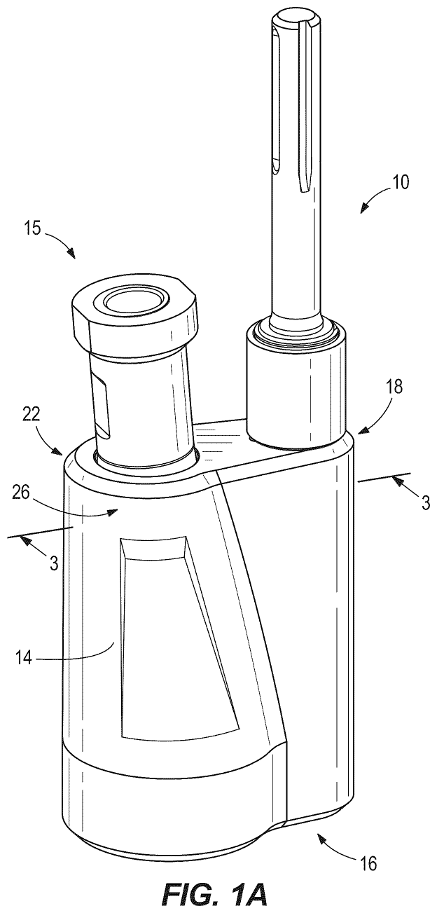

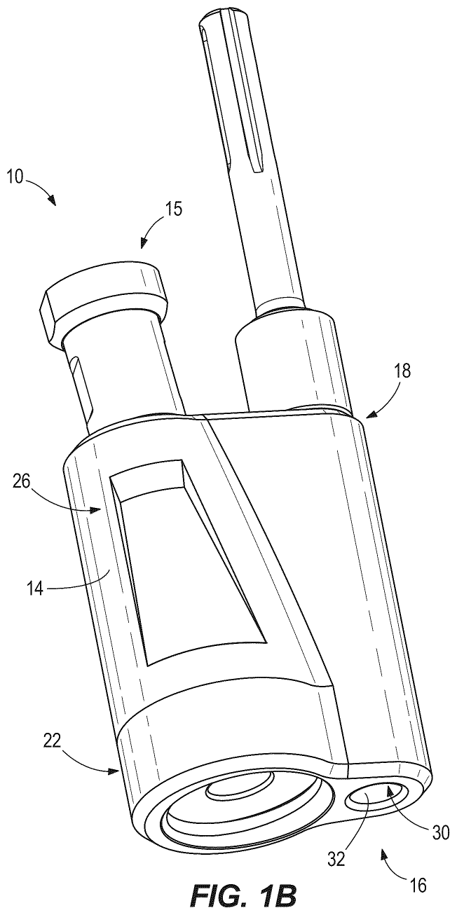

FIGS. 1A and 1B illustrate an attachment 10 configured for use with a reciprocating power tool (e.g., a powered hammer, not shown) to drive a rod 13 (FIGS. 4A, 4B) into the ground. The attachment 10 includes a body 14 having a first end 15 and a second end 16 opposite the first end 15. The attachment 10 further includes an impact portion 18 and a driving portion 22 disposed within the body 14. The impact portion 18 is positioned on the first end 15 of the body 14 and receives impacts from the powered hammer, and the driving portion 22 transmits a driving force generated by the impacts to the rod 13 to drive the rod 13 into the ground. More particularly, the illustrated driving portion 22 includes a side load driving portion 26 and a top load driving portion 30 (FIG. 1B). The side load driving portion 26 transmits the driving force to sides of the rod 13, while the top load driving portion 30 is positioned on the second end 16 of the body 14 and transmits the driving force to a top end of the rod 13. In operation, the side load driving portion 26 is used to drive the rod 13 into the ground until the rod 13 is nearly driven into the ground. When the rod 13 is nearly driven into the ground, an operator is able to switch to the top load driving portion 30 to complete driving the rod 13 into the ground. The attachment 10 of the present disclosure allows for efficient driving of the rod 13 into the ground, without the operator needing to switch attachments to complete the driving process.

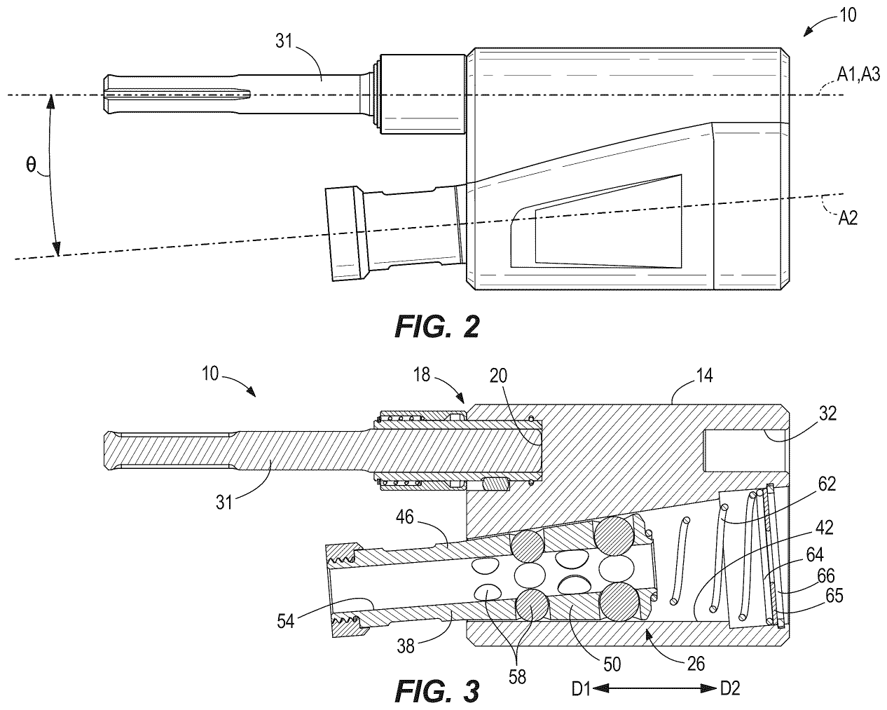

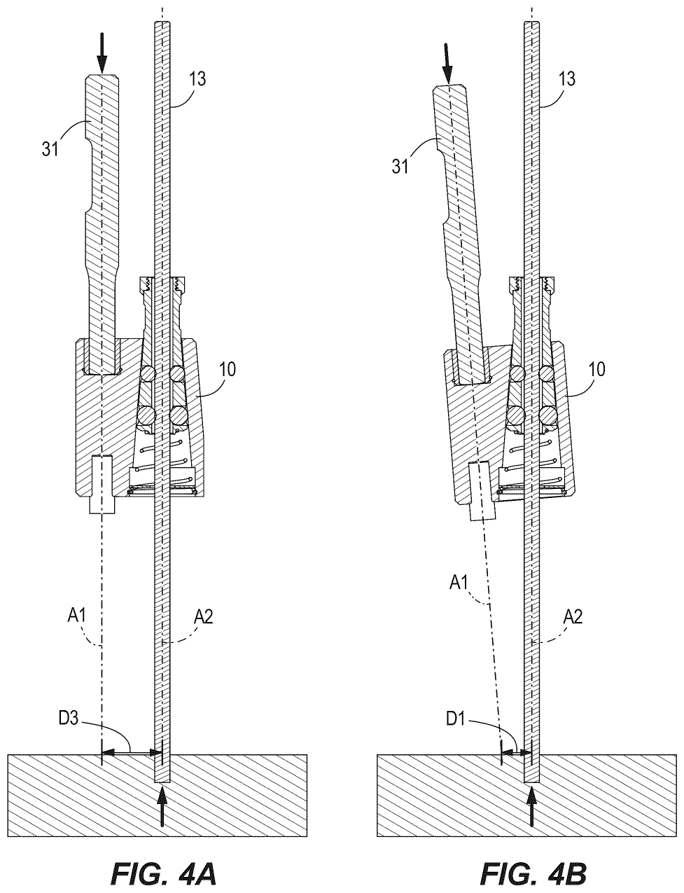

With reference to FIG. 3, the impact portion 18 is located on a first side of the body 14. The illustrated impact portion 18 includes a bore 20. More particularly, the bore 20 is a blind bore. A longitudinal axis of the impact portion 18 defines an impact axis A1 (FIG. 2). The impact portion 18 is shaped to receive a drive shank 31 of a powered hammer to couple the attachment 10 to the powered hammer. An interference fit may exist between the drive shank 31 and the impact portion 18 such that impacts from the powered hammer during operation secure the drive shank 31 within the impact portion 18 (e.g., the blind bore 20). The impact portion 18 may include a sizing feature, such as an insert, adapted to adjust a diameter of the impact portion 18 to accommodate different size shanks. In some embodiments, the drive shank 31 is coupled to the body 14 via a quick-connect system, rather than an interference fit, so that the drive shank 31 is replaceable. The quick connect system may be similar to a chuck of the powered hammer. In yet other embodiments, the drive shank 31 is a post extending from the body 14 and integrally formed with the body 14. The post is shaped to be received within the chuck of the powered hammer to received repeated impacts therefrom. Other attachment systems are described in more detail below.

With continued reference to FIG. 3, the side load driving portion 26 includes a one-way collet 38 for selectively securing the rod 13 relative to the body 14 of the attachment 10 and transmitting the driving force from the powered hammer into the rod 13 to drive the rod 13 into the ground. A longitudinal axis of the side load driving portion 26 defines a side load driving axis A2 (FIG. 2). The collet 38 allows the attachment 10 to move relative to the rod 13 in a first direction DI along the side load driving axis A2 and prevents relative motion between the rod 13 and the attachment 10 in a second direction D2 along the driving axis A2. The second direction D2 is the driving direction (e.g., into the ground). In operation, the one-way collet 38 prevents the attachment 10 from moving along the rod 13 towards the ground, thereby facilitating the driving of the rod 13, while allowing the attachment 10 to be moved along the rod 13 away from the ground, thereby allowing the operator to re-position the attachment 10 along the rod 13 as the rod 13 is driven into the ground.

With continued reference to FIG. 3, the body 14 defines an aperture 42 in which the collet 38 is received. In the illustrated embodiment, the aperture 42 is a frustoconical aperture. The aperture 42 narrows towards a top of the attachment 10 (e.g., proximate the powered hammer). The illustrated collet 38 includes a cylindrical portion 46, a frustoconical portion 50, and a central bore 54 extending a length of the collet 38 and adapted to receive the rod 13 therein. The cylindrical portion 46 is located at a top of the collet 38 and extends beyond the body 14 of the attachment 10 through the narrow portion of the aperture 42. The frustoconical portion 50 is sized and shaped to fit within the frustoconical aperture 42 of the body 14. For example, the frustoconical portion 50 of the collet 38 has a similar slope to the frustoconical aperture 42 of the body 14. The slope of the illustrated embodiment is 5 degrees. In other embodiments, the slope of the collet 38 may be greater than or less than 5 degrees.

Spaced circumferentially about the frustoconical portion 50 are a plurality of ball bearings 58. The ball bearings 58 partially extend radially into the central bore 54 to engage the rod 13 and transmit driving forces to the rod 13. The collet 38 of the illustrated embodiment includes four rows of differently sized ball bearings 58. Each row of bearings 58 is offset from the rows above and/or below. In the illustrated embodiment, the offset angle between each row is 45 degrees. Each bearing 58 within a row is of the same nominal size, while bearings 58 in adjacent rows have different nominal sizes. The difference between bearing sizes in adjacent rows corresponds to the slope of the frustoconical portion 50. In other words, as the aperture 42 widens, the bearings 58 increase in size. This allows each bearing 58 to simultaneously engage the rod 13 when the rod 13 is inserted in the collet 38. In other embodiments, the collet 38 may include more or fewer bearings 58 in each row, more or fewer rows of bearings 58, and a greater or smaller offset between rows of bearings 58, depending on the desired size of the attachment 10 and desired diameter of rods 13 to be driven by the attachment 10. However, irrespective of the number or offset, the bearings 58 are sized to correspond to the slope of the frustoconical portion 50 to properly secure the rod 13. Each bearing 58 equally engages the rod 13 to reduce marring during the driving operation. Marring can decrease the grounding capabilities of the rod 13 after it is driven, and therefore should be avoided.

The side load driving portion 26 further includes a biasing member 62 to bias the collet 38 against the aperture 42 and an end cap 64 to maintain the collet 38 within the aperture 42. In other words, the biasing member 62 is configured to bias the collet 38 towards the first end 15 of the body 14. The end cap 64 is located below the collet 38 (i.e., closer than the collet 38 to the second end 16 of the body 14). The biasing member 62 is disposed between the end cap 64 and the collet 38. In one embodiment, the biasing member 62 is a conical compression spring, and the end cap 64 is a washer secured within the aperture 42 by a snap ring 66. The snap ring 66 is received in a groove 65 of the aperture 42. The snap ring 66 has a thickness (measured parallel to the driving axis A2) that is equally or nearly equal to a height of the groove 65 (measured parallel to the driving axis A2). Such an arrangement helps eliminate relative movement of the snap ring 65 within the aperture 42, reducing potential failures (e.g., breaking) of the snap ring 65. In another embodiment, the biasing member 62 is a cylindrical compression spring, and the end cap 64 is a cup extending from a bottom of the aperture 42 and secured to the aperture 42 via a threaded connection.

The side load driving portion 26 is capable of driving rods of various diameters. For example, the attachment 10 can be used to drive rods 13 of ½″, ⅝″, or ¾″ diameters. In some embodiments, the attachment 10 can be used to drive rods 13 of ⅜″ or 1″ diameters. The slope of the frustoconical portions 42, 50 dictates the size of rods 13 that can be driven. More particularly, the collet 38 is movable within the aperture 42, against the force of the biasing member 62, to accommodate larger diameter rods. As the collet 38 moves towards the end cap 66, the aperture 42 widens and allows the bearings 58 to move radially outwards to accommodate a larger diameter rod 13, while being able to contact both the body 14 and the rod 13. The use of a conical spring as the biasing member 62 allows for a shorter overall attachment length (e.g., the washer end cap 64 rather than the cup), because the conical spring is compressible to a flatter shape than a cylindrical compression spring. In other words, the use of a cylindrical compression spring requires the cup-shaped end cap to provide clearance for the collet 38 to move within the aperture 42 and accommodate larger diameter rods 13.

With reference to FIGS. 1B and 3, the top load driving portion 30 is illustrated as a blind bore 32 on a bottom side of the body 14 (e.g., the second end 16 of the body 14). A longitudinal axis A3 (FIG. 2) of the top load driving portion 30 is parallel with the impact axis A1. In the illustrated embodiment, the longitudinal axis A3 is coaxial with the impact axis A1. In some embodiments, the longitudinal axis A3 of the top load driving portion is offset from the impact axis A1 or non-parallel. Furthermore, in some embodiments, the top load driving portion 30 may be formed as a post extending below the body 14 and having the blind bore 32 therein.

In some embodiments, the body 14 includes an accessory receiving portion that is configured to receive an accessory that assists in the grounding operation. One such accessory is a step that can be fastened to the attachment 10. The step may include, for example a bar or strap extending from a side of the attachment 10. Another such accessory is a handle that can be fastened to the attachment 10 via fastener receiving holes. In operation, the step allows a user to apply a force to the attachment 10, and thus the rod 13, with their foot while driving the rod 13. This force can steady the rod 13 during driving and may also increase the efficiency of the driving by applying a downward force (e.g., in the same direction as the driving force).

The attachment 10 of the present disclosure is optimized for efficient driving of the rod 13. The optimization is in part due to decreasing the overall mass of the attachment 10. Having less mass below the impact point of the powered hammer results in a greater driving force being transmitted to the rod 13. To accomplish this, the overall size of the body 14 is decreased, and the body 14 is formed of lightweight and strong materials such as aluminum or magnesium. For example, compared to a similar attachment made of steel, an attachment made of aluminum may weigh about 65% less, while an attachment made of magnesium may weight about 80% less. In the illustrated embodiment, the impact portion 18 and the driving portion 22 of the body 14 are integrally formed as a single piece. In such embodiments, the impact portion 18 and the driving portion 22 may be formed of the same material. In other embodiments, the impact portion 18 and the driving portion 22 may be separate pieces that are secured (e.g., fastened, welded, etc.) together. In such embodiments, the impact portion 18 and the driving portion 22 may be formed of the same material or may be formed of different materials from each other.

Referring now to FIG. 3, the side load driving axis A2 is angled relative to the impact axis A1. In other words, the side load driving portion 26, the aperture 42, and the collet 38 are angled relative to the impact axis A1. The side load driving axis A2 and the impact axis A1 define an angle θ. The illustrated angle θ is an acute angle. In some embodiments, the angle θ is less than 20 degrees. Preferably, the angle θ is 4.5 degrees. In other embodiments, the angle θ may be greater than 20 degrees. In further embodiments, the side load driving axis A2 and the impact axis A1 are offset and parallel. Having the side load driving axis A2 angled relative to the impact axis A1 increases the rod driving efficiency by decreasing an offset distance D3 (FIG. 4B) between the impact axis A1 and the side load driving axis A2. A shorter offset distance between the impact axis A1 and the side load driving axis A2 decreases the bending moment arm applied to the rod 13 during impacts and allows more of the force from the impact to be transferred to the rod 13 to drive the rod 13 linearly into the ground. For example, as shown in FIG. 4A, an offset distance D3 is defined between the rod 13 and the impact axis A1 at a position where the rod 13 contacts the ground. The offset distance D3 is measured in a direction that is parallel to the ground or perpendicular to the rod 13. As illustrated in FIG. 4A, the offset distance D3 is generally going to be the offset distance between the impact axis A1 and the side load driving axis A2. However, as shown in FIG. 4B, by angling the side load driving axis A2 relative to the impact axis A1, the offset distance D3 can be reduced further or completely reduced to zero. In addition, by having the angle e be small, the horizontal force vector applied to the rod 13 during operation is negligible allowing the vertical vector force provided to the rod 13 to be nearly the full force applied by the power tool to the impact portion 18.

In the illustrated embodiment, the side load driving portion 26 and the side load driving axis A2 are angled relative to the impact portion 18 and impact axis A1 so that the impact axis A1 remains generally parallel with the outside edge of the body 14. In other embodiments, the impact portion 18 and impact axis A1 may be angled relative to the side load driving portion 26 and side load driving axis A2 so that the side load driving axis A2 is generally parallel to the outside edge of the housing.

To drive a rod 13 with the above-described attachment 10, the operator first couples the attachment 10 to the powered hammer via the impact portion 18. In the illustrated embodiment, the drive shank 31 is inserted into the chuck of the powered hammer. If the attachment 10 has not been used before (e.g., the drive shank 31 is not secured within the impact portion 18), the operator also inserts the drive shank into the blind bore 20 of the impact portion 18. Next, the rod 13 is inserted into the side load driving portion 26 from above the attachment 10. The insertion direction corresponds to the direction DI in which the collet 38 allows for relative movement of the rod 13 and the attachment 10 (e.g., opposite the driving direction D2). At this point, the rod 13 can be aligned with the ground at a desired location and the operator can actuate the powered hammer to begin driving the rod 13. As the rod 13 is driven, the operator adjusts the position of the attachment 10 relative to the length of the rod 13 until the rod 13 is nearly driven into the ground. At this point, the operator will release the side load driving portion 26 from the rod 13 and insert a top of the rod 13 into the top load driving portion 30 to complete driving the rod 13 into the ground. While the steps of a driving operation have been described in a particular order above, one or ordinary skill in the art will understand the ability to perform the steps in a different order.

Table 1 below illustrates the average time in seconds to complete driving rods 13 of different lengths into the ground using various attachments. As evidenced by the table, the attachment 10 with the side load driving axis A2 angled relative to the impact axis A1 reduced the driving time by over half compared to attachments that are not angled.

TABLE 1
Average Time (seconds) to Complete Driving Operation

| Sample Rod Size (feet) | 3 | 4 | 5 | 6 |
|---|---|---|---|---|
| Attachment #1 (not angled) | 75.95 | 107.24 | 136.53 | 201.89 |
| Attachment #2 (not angled) | 80.66 | 120.17 | 156.34 | 185.95 |
| Attachment 10 (angled) | 36.34 | 53.38 | 68.07 | 89.48 |

In some embodiments, hardened steel may be included to increase the strength of high wear areas of the body 14. For example, a hardened steel sleeve may be applied to the top load driving portion 30 so that the bore 32 is not overly worn during operation. Similarly, the collet 38 and the end cap 64 can be formed of high strength steel, and a different steel sleeve may be applied to the aperture 42 so that the bearings 58 do not mar the body 14 of the attachment 10 during use.

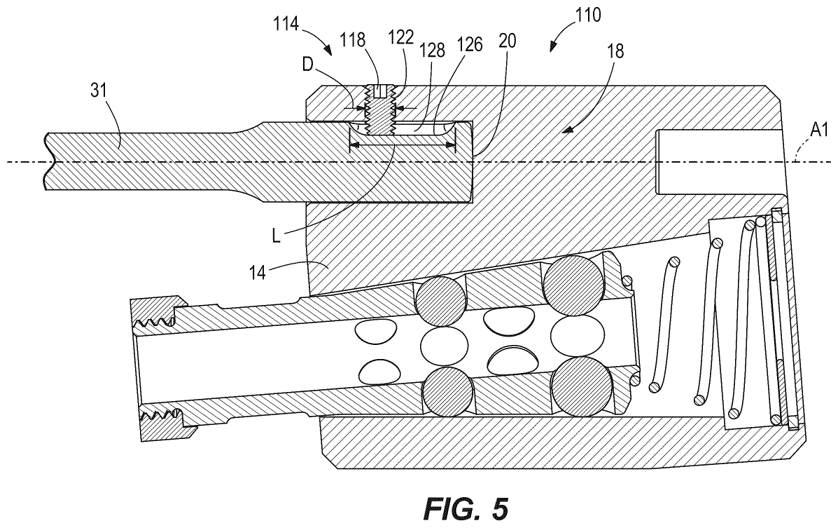

FIG. 5 illustrates an attachment 110 according to another embodiment of the invention. The attachment 110 is similar to the attachment 10 described above with like features being represented with like reference numbers. The illustrated attachment 110 includes a retention device 114 to selectively secure the shank 31 within the bore 20 of the impact portion 18. As mentioned above, the attachment 10, 110 may include a dedicated drive shank 31 that is removably coupled to the bore 20 of the impact portion 18. The retention device 114 includes a locking mechanism 118 that is received in an opening 122 in the body 14. In the illustrated embodiment, the locking mechanism 118 is a fastener, such as a set screw. In other embodiments, the locking mechanism 118 may include other types of threaded or non-threaded fasteners or inserts. For example, the locking mechanism 118 may include a pin, a spring-loaded detent, a clevis pin, a spring pin, a quick-release pin, a through bolt with a nut, or the like. The opening 122 extends to the bore 20 of the impact portion 18. The drive shank 31 includes a recessed or flat surface side 126 that the locking mechanism 118 engages when the drive shank 31 is received within the bore 20. The flat surface side 126 defines a groove 128 in the drive shank 31. To couple the shank 31 to the attachment 110, an operator may place the drive shank 31 in the bore 20 and insert (e.g., thread) the locking mechanism 118 into the opening 122 to secure the drive shank 31 in place. Conversely, an operator may remove the locking mechanism 118 from the opening 122 in order to remove the drive shank 31 from the bore 20.

The engagement of the locking mechanism 118 and drive shank 31 provides a sufficient force to retain the drive shank 31 within the bore 20. However, due to the flat surface side 126 on the drive shank 31, the drive shank 31 is allowed to minimally move axially along the impact axis A1. In particular, the locking mechanism 118 has a dimension D (e.g., a diameter) measured parallel to the impact axis A1 that is less than a length L measured parallel to the impact axis A1 of the groove 128. As such, the drive shank 31 is allowed to float within the bore 20. During operation of the attachment 110, large compressive forces are transferred to the attachment 110 through the drive shank 31 that is coupled to a percussive power tool. Allowing the drive shank 31 to float in the bore 20 during a drive operation lets the compressive force from the power tool transfer to the drive shank 31 and rod 13 without a resultant tensile force. As a result, fatigue failures to the drive shank 31 and attachment 110 are reduced. In addition, allowing the drive shank 31 to float in the bore 20 dampens the percussive force reducing user fatigue during a driving operation. Further, the retention device 114 allows a user to change a drive shank 31 that has broken without needing to buy a completely new attachment.

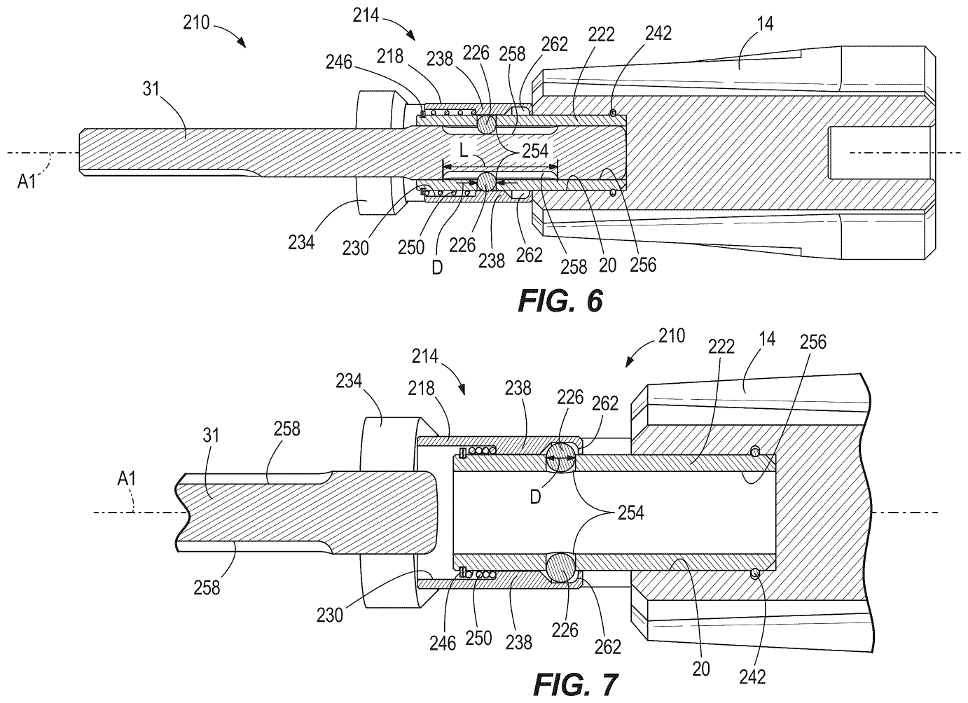

FIGS. 6 and 7 illustrate an attachment 210 according to another embodiment of the invention. The attachment 210 is similar to the attachment 10 described above with like features being represented by like reference numbers. The illustrated attachment 210 includes a retention device 214 to selectively secure the drive shank 31 to the attachment 210. The retention device 214 includes an external sleeve 218, an internal sleeve 222, and a locking mechanism (e.g., ball bearings 226). The external sleeve 218 is coupled to the body 14 adjacent the bore 20 and includes a channel 230 extending along the impact axis A1. The external sleeve 218 also includes an end cap 234 at one end and a pair of lips 238 extending from an interior surface of the channel 230 in a direction radially inward. The internal sleeve 222 is positioned within the external sleeve 218 and includes a portion that extends into the bore 20. A first snap ring 242 secures the internal sleeve 222 within the bore 20, and a second snap ring 246 assists in securing the internal sleeve 222 within the external sleeve 218. A biasing member (e.g., compression spring 250) is positioned within the channel 230 of the external sleeve 218 between the lips 238 and the second snap ring 246. The lips 238 and the second snap ring 246 act as spring seats for the biasing member 250. The biasing member 250 biases the external sleeve 218 axially towards the body 14. The ball bearings 226 are positioned within respective openings 254 in the internal sleeve 222. In the illustrated embodiment, the retention device 214 includes two ball bearings 226. In other embodiments, the retention device 214 may include fewer or more ball bearings 226.

In a locked position (FIG. 6), the lips 238 of the external sleeve 218 are positioned adjacent the openings 254 and the ball bearings 226. In the locked positioned, the lips 238 force the ball bearings 226 to partly extend into a channel 256 defined by the internal sleeve 222 to engage grooves 258 on the drive shank 31. Similar to the locking mechanism 118, each ball bearing 226 has a dimension D (e.g., a diameter) measured parallel to the impact axis A1 that is less than a length L of the corresponding groove 258. The ball bearings 226 retain the drive shank 31 during a driving operation.

To remove or replace the drive shank 31 from the attachment 210, a user can pull up on the end cap 234 away from the body 14 and against the bias of the biasing member 250 to an unlocked position (FIG. 7). As the external sleeve 218 moves away from the body 14 of the attachment 210, the lips 238 on the inside surface of the channel 230 are removed from the openings 254 in the internal sleeve 222, allowing the ball bearings 226 to travel into pockets 262 of the external sleeve 218. With the ball bearings 226 removed from the internal channel 256, the drive shank 31 is allowed to be removed from the bore 20 of the impact portion 18. Conversely, a user can lift the end cap 234 away from the body 14 in order to couple the drive shank 31 to the attachment 210. Similar to the attachment 110 above, the ball bearings 226 allow the drive shank 31 to minimally move axially or float within the bore 20 in order to reduce fatigue to the drive shank 31 and attachment 210.

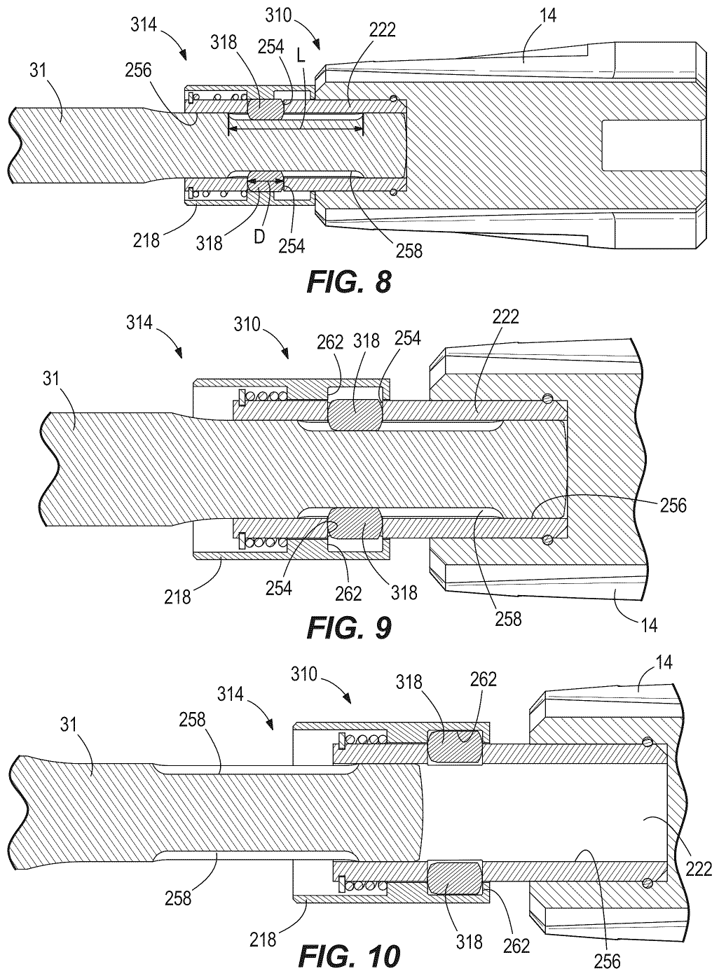

FIGS. 8-10 illustrate an attachment 310 according to another embodiment of the invention. The attachment 310 is similar to the attachment 210 described above, with like features being represented with like reference numbers. The illustrated attachment 310 includes a retention device 314 similar to the retention device 214 described above, however, the retention device 314 includes dowel pins 318 instead of ball bearings 226. In the illustrated embodiment, the retention device 314 includes two dowel pins 318. In other embodiments, the retention device 314 may include fewer or more dowel pins 318. The dowel pins 318 are resilient and cylindrical shaped so that the pins 318 are allowed to rotate within the openings 254 and compress within the openings 254. In addition, the pockets 262 of the external sleeve are sized to receive the dowel pins 318 instead of the ball bearings 226. Similar to the locking mechanism 118 and the ball bearings 226, each dowel pin 318 has a dimension D (e.g., a length) measured parallel to the impact axis A that is less than a length L of the corresponding groove 258.

In the locked position (FIG. 8), the pockets 262 are offset circumferentially from the openings 254 of the internal sleeve 222 so a user also rotates the external sleeve 218 to release the drive shank 31. The pockets 262 may be offset from the openings 254 by up to 90 degrees. As such, to release the drive shank 31, the user first lifts the external sleeve 218 away from the body 14 as shown in FIG. 9. Next, a user rotates the external sleeve 218 in a first direction to align the pockets 262 with the openings 254, allowing the pins 318 to retreat from the channel 256 of the internal sleeve 222 and the grooves 258 on the shank 31 (FIG. 10). The user can then remove the drive shank 31 from the bore 20. Similar to the attachment 110 above, the dowel pins 318 allow the drive shank 31 to minimally move axially or float within the bore 20 in order to reduce fatigue to the drive shank 31 and attachment 310.

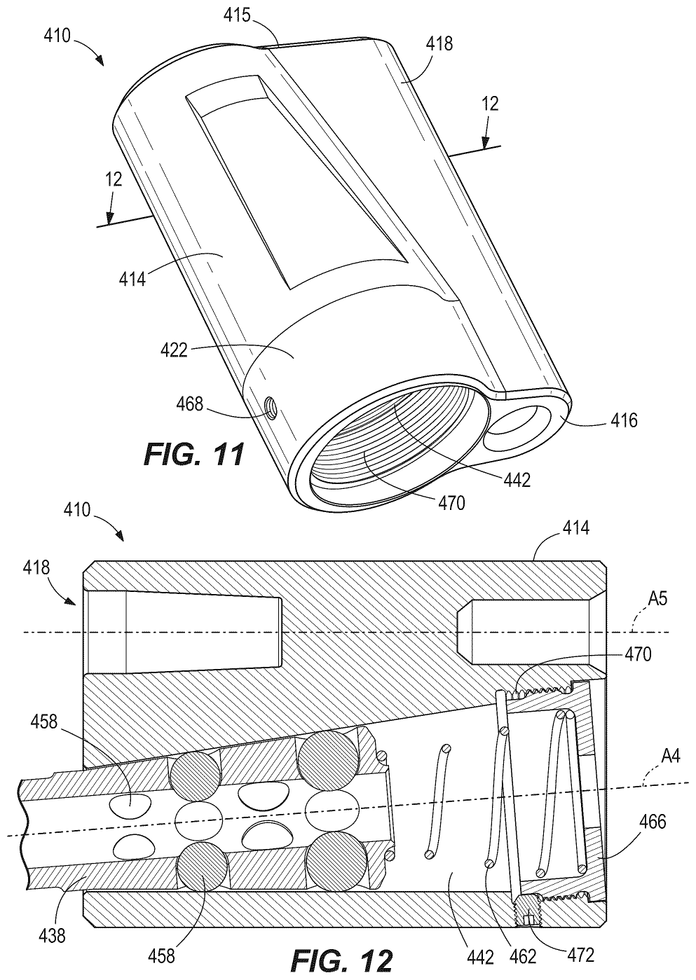

FIGS. 11 and 12 illustrate an attachment 410 according to another embodiment of the invention. The attachment 410 is similar to the attachment 10 described above with like features being represented by like reference numbers plus “400.” The illustrated attachment 410 includes a body 414 having a first end 415 and a second end 416. The attachment 410 further includes an impact portion 418 and a driving portion 422 disposed within the body 414. Similar to the attachment 10, the illustrated driving portion 422 is a side load driving portion including a one-way collet 438 positioned at least partially within an aperture 442 of the body 414. The one-way collet 438 includes ball bearings 458 and is configured to transmit a driving force generated by the impacts from a powered hammer to the rod 13. As shown in FIG. 12, the one-way collet defines a driving axis A4 that is angled relative to an impact axis A5 of the impact portion 418. The driving portion 422 also includes a biasing member 462 to bias the collet 438 against the aperture 442 and an end cap 466, 466′ to maintain the collet 438 within the aperture 442. The end cap 466, 466′ is located below the collet 438 (i.e., closer than the collet 438 to the second end 416 of the body 414). The biasing member 462 is disposed between the end cap 466, 466′ and the collet 438.

In the illustrated embodiment, the aperture 442 includes a threaded section 470 adjacent the second end 416 of the body 414. The aperture 442 also includes a side bore 468 extending from a side of the body 414 to the threaded section 470 of the aperture 442. The side bore 468 is configured to receive a set screw or other suitable fastener 472. For example, in some embodiments, the fastener 472 may be a dowel pin. The dowel pin may be press-fit into the aperture 422. In such embodiments, the aperture 442 may not be threaded. The threaded section 470, the side bore 468, and the fastener 472 couple the end cap 466, 466′ to the body 414.

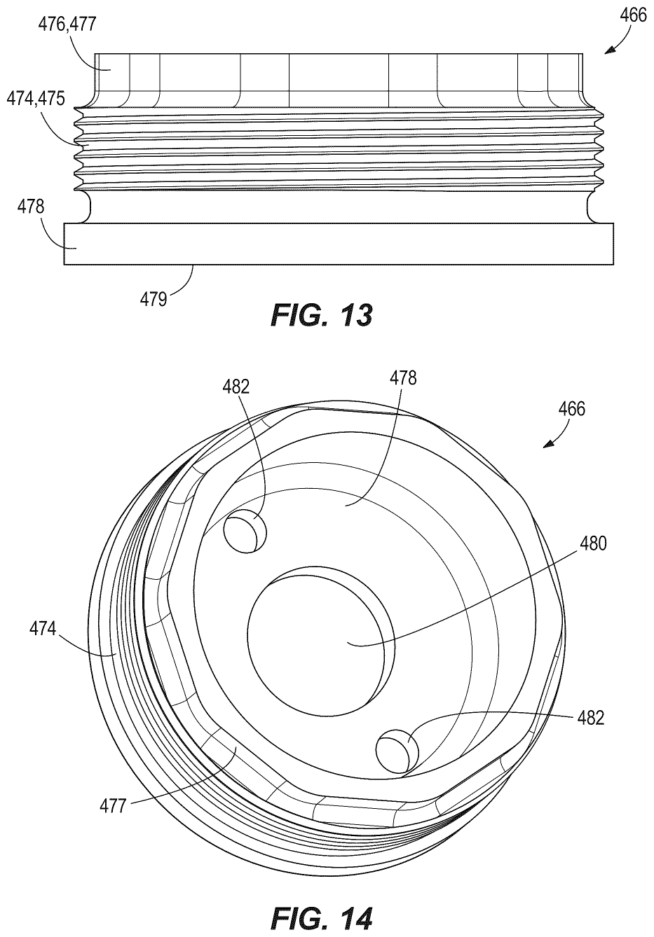

FIGS. 13 and 14 illustrate one example of the end cap 466. The illustrated end cap 466 includes a base 478 and a sidewall 474 extending from the base 478. As such, the end cap 466 is generally cup-shaped. The base 478 engages the biasing member 462. A central bore 480 is formed in the base 478 to allow the rod 13 to pass through the end cap 466 as the rod 13 is driven into the ground. The base 478 also defines one or more holes 482. The holes 482 are configured to receive a suitable tool or other object (e.g., a bolt, a screw, a pin, etc.) to help rotate the end cap 466 during installation and removal of the end cap 466 into and from the body 414.

The sidewall 474 includes a threaded segment 475 and an unthreaded segment 476. The threaded segment 475 is positioned adjacent the base 478 and configured to threadedly couple or engage the threaded section 470 of the aperture 442. The unthreaded segment 476 is positioned opposite from the base 478 and has a smaller outer diameter than the threaded segment 475. As such, the unthreaded segment 476 does not engage the threaded section 470 of the aperture 442. Rather, the illustrated unthreaded segment 476 includes one or more planar wall segments or flats 477. In the illustrated embodiment, the unthreaded segment 476 includes a plurality of flats 477 spaced continuously around an outer surface of the sidewall 474. In other embodiments, the unthreaded segment 476 may only include a single flat 477 or may include a few flats 477 space sporadically around the outer surface of the sidewall 474. The flats 477 are configured to be engaged by the fastener 472 to secure the end cap 466 in the body 414.

To install the end cap 466, the end cap 466 is inserted into the aperture 442 through the second end 416 of the body 414. When the threaded segment 476 of the end cap 466 reaches the threaded section 470 of the aperture, the end cap 466 is then rotated to thread the end cap 466 into the threaded section 470. In some embodiments, the end cap 466 is threaded into the aperture 442 until an outer or bottom surface 479 of the base 478 is flush or near flush with an outer surface of the body 414. That is, the bottom surface 479 may be slightly recessed relative to, or extend slightly beyond, the outer surface of the body 414. Once the end cap 466 is inserted a suitable distance into aperture 442, the fastener 472 is tightened (e.g., rotated or press-fit). As the fastener 472 is tightened in the side bore 468, the fastener 472 extends into the aperture 442 and engages one of the flats 477. The fastener 472 may be tightened until a firm, frictional contact is established with the upper wall segment 476. The contact between the fastener 472 and the upper wall segment 476 secures the end cap 466 in place and inhibits the end cap 466 from reversing out from its threaded connection with the body 414.

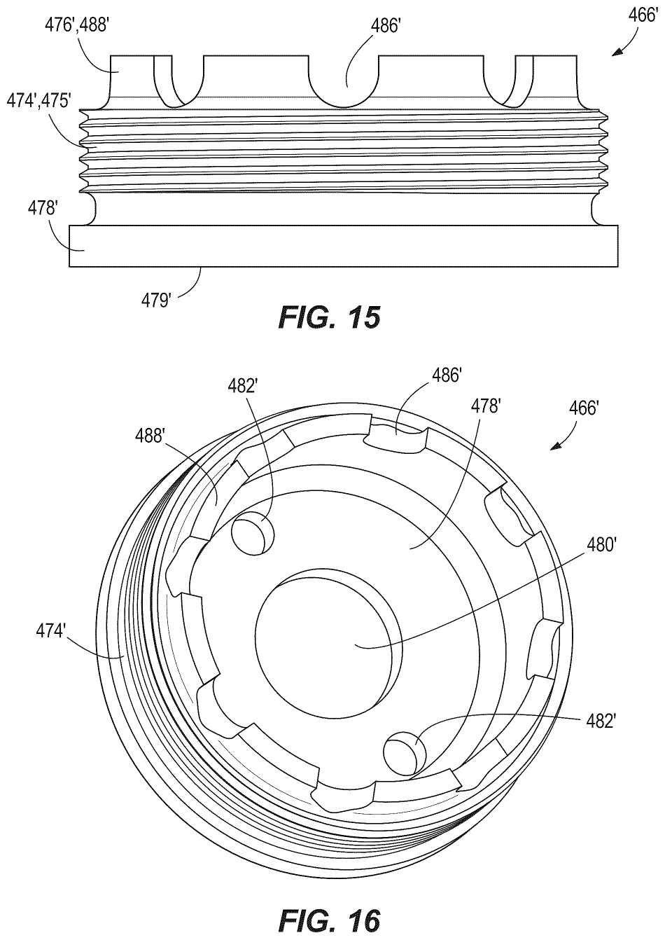

FIGS. 15 and 16 illustrate another example of the end cap 466′. The illustrated end cap 466′ is similar to the end cap 466 described above and includes a base 478′ with a central bore 480′ and holes 482′, and a sidewall 474′ with a threaded segment 475′ and an unthreaded segment 476′. In the illustrated embodiment, however, the unthreaded segment 476′ of the sidewall 474′ defines a plurality of notches 486′ rather than the plurality of flats 477. In the illustrated embodiment, the unthreaded segment 476′ defines eight notches 486′ spaced circumferentially around a circumference of the sidewall 474′. In other embodiments, the unthreaded segment 475′ may define fewer or more notches 486′, such as a single notch 486′ or more than eight notches 486′, and/or the notches 486′ may be unevenly spaced around the circumference of the sidewall 474′. Each notch 486′ is formed between a pair of adjacent protrusions 488′ and is configured to receive the fastener 472. In the illustrated embodiment, the notches 486′ extend through an upper edge of the sidewall 474′. In addition, the notches 486′ are through holes that extend through the sidewall 474′. In other embodiments, the notches 486′ may be spaced from the upper edge of the sidewall 474′ (i.e., the notches 486′ may be bounded on all sides by the sidewall 474′). Additionally or alternatively, the notches 486′ may be depressions that do not extend entirely through the sidewall 474′.

Once the end cap 466′ is inserted a suitable distance into the aperture 442 (e.g., in a manner similar to the end cap 466), the fastener 472 is tightened (e.g., rotated or press-fit). As the fastener 472 is tightened in the side bore 468, the fastener 472 extends into the aperture 442 and is received in one of the notches 486′ between a respective pair of protrusions 488′. The fastener 472 thereby engages the pair of protrusions 488′ such that the end cap 466′ is secured in place and inhibited from reversing out from its threaded connection with the body 414.

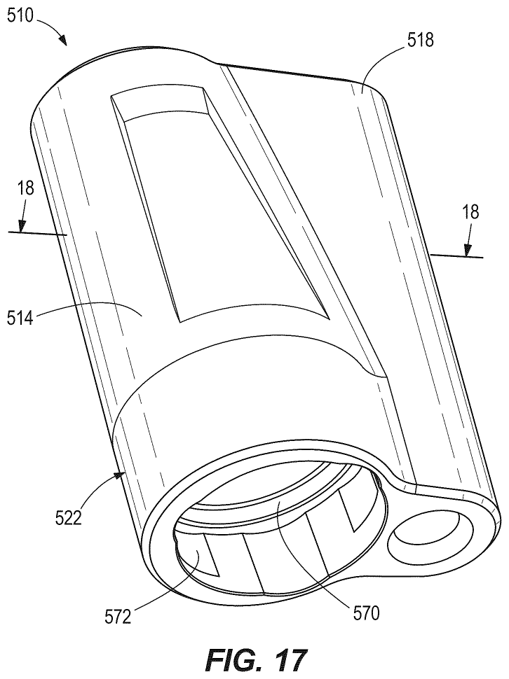

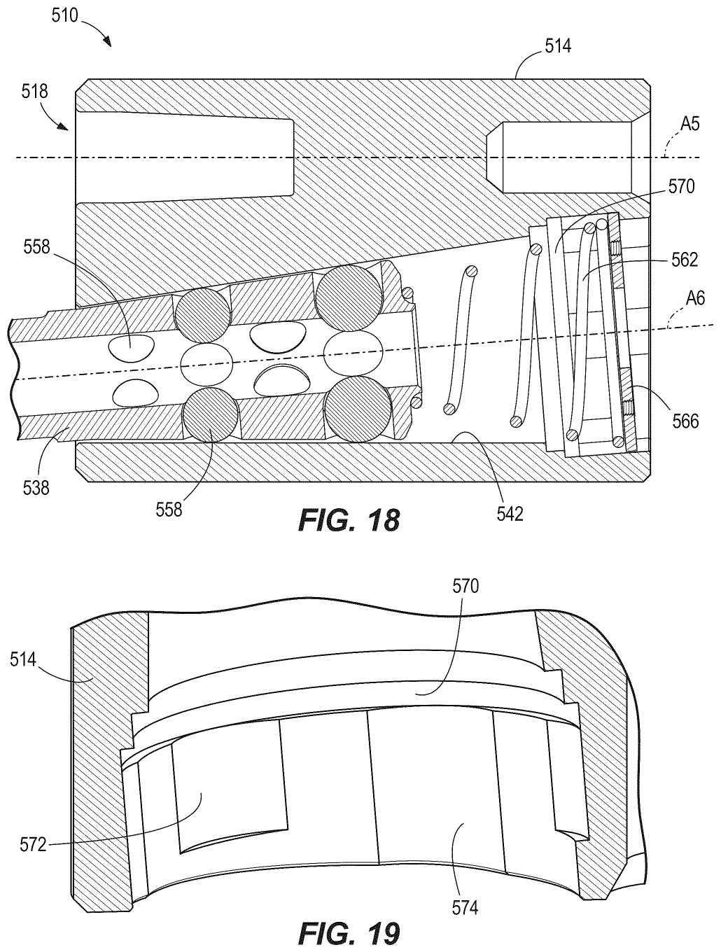

FIGS. 17 and 18 illustrate an attachment 510 according to another embodiment of the invention. The attachment 540 is similar to the attachment 10 described above with like features being represented by like reference numbers plus “500.” The illustrated attachment 410 includes a body 514 having a first end 515 and a second end 516. The attachment 510 further includes an impact portion 518 and a driving portion 522 disposed within the body 514. Similar to the attachment 10, the illustrated driving portion 522 is a side load driving portion including a one-way collet 538 positioned at least partially with an aperture 542 of a body 514. The one-way collet 538 includes ball bearings 558 and is configured to transmit a driving force generated by the impacts from the powered hammer to the rod 13. As shown in FIG. 18, the one-way collet 538 defines a driving axis A6 that is angled relative to an impact axis A7. The driving portion 522 also includes a biasing member 562 to bias the collet 538 against the aperture 542 and an end cap 566 to maintain the collet 538 within the aperture 542. The end cap 566 is located below the collet 538 (i.e., closer than the collet 538 to the second end 516 of the body 514). The biasing member 562 is disposed between the end cap 566 and the collet 538.

As shown in FIG. 19, in the illustrated embodiment, the aperture 542 includes a groove 570 adjacent the second end 516 of the body 514. The aperture 542 also includes a plurality of recesses or cavities 572 that are formed in an inner surface of the body 514 between the groove 570 and the second end 516 of the body 514. The cavities 572 connect to the groove 570 and form smooth transitions from a larger diameter section of the aperture 542 to the groove 570. In addition, the cavities 572 are spaced apart from each other to define ledges 574 between adjacent cavities 572. In the illustrated embodiment, the aperture 542 includes at least three cavities 572. In other embodiments, the aperture 542 may include fewer or more cavities 572.

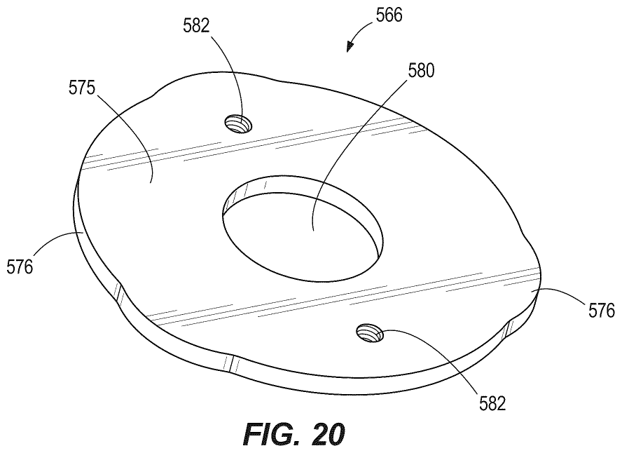

FIG. 20 illustrates the end cap 566. The illustrated end cap 566 includes a plate 575 having a plurality of lobes 576. In the illustrated embodiment, the end cap 566 includes three lobes 576. In other embodiments, the end cap 566 may include fewer or more lobes 576. The lobes 576 are shaped and sized to fit and slide within the cavities 572 when the end cap 566 is inserted into the aperture 542 to reach the groove 570. Once the end cap 566 is aligned with the groove 570, the end cap 566 is rotated (e.g., a quarter turn) such that the lobes 576 engage or rest on the ledges 574. A central bore 580 is formed through the plate 575 to allow the rod 13 to pass through the end cap 466 as the rod 13 is driven into the ground. The plate 575 also defines one or more holes 582. The holes 482 are configured to receive a suitable tool or other object (e.g., a bolt, a screw, a pin, etc.) to help rotate the end cap 566 during installation and removal of the end cap 566 into and from the body 514. Although the illustrated holes 482 are threaded, in other embodiments the holes 482 may not be threaded.

The attachments 10, 110, 210, 310, 410, and 510 have been described with respect to driving electrical ground rods 13. However, one of ordinary skill in the art will understand that the attachment 10 can be used for driving other rods and stakes as well.

Although not illustrated together, the features described above may be used together in any combination in a single attachment. For example, any of the end caps 466, 466′, 566 may be used with any of the retention devices 114, 214, 314 described above. As such, an attachment may have a driving portion that is angled relative to an impact portion, a retention device that allows a drive shank to float, and an end cap that securely maintains a collet within the driving portion.

Although the invention has been described in detail with reference to certain preferred embodiments, variations and modifications exist within the scope and spirit or one or more independent aspects of the invention as described.

What is claimed is:

1. An attachment configured for use with a powered hammer to drive a rod into the ground, the attachment comprising:
a body;
an impact portion defining an impact axis, the impact portion including a bore configured to receive a drive shank that is coupled to the powered hammer, the impact portion configured to receive repeated impacts from the powered hammer; and
a driving portion in which the rod is receivable, the driving portion including a side load driving portion defining a side load driving axis, the side load driving axis being non-parallel to the impact axis.

2. The attachment of claim 1, wherein the impact axis and the side load driving axis are orientated at an acute angle relative to one another.

3. The attachment of claim 2, wherein the acute angle is less than 20 degrees.

4. The attachment of claim 3, wherein the acute angle is 4.5 degrees.

5. The attachment of claim 1, wherein the side load driving portion includes a one-way collet configured to transmit a driving force generated by the impacts from the powered hammer to a side of the rod, wherein the one-way collet is configured to allow the attachment to move relative to the rod in a first direction and to prevent relative movement between the attachment and the rod in a second direction, opposite the first direction.

6. The attachment of claim 5, wherein the one-way collet includes a frustoconical portion, and wherein the body defines a frustoconical aperture in which the one-way collet is received.

7. The attachment of claim 6, wherein the one-way collet includes a plurality of bearings disposed about the frustoconical portion, the plurality of bearings configured to engage the rod.

8. The attachment of claim 7, further comprising a biasing member that biases the one-way collet toward a position corresponding to a minimum rod diameter.

9. An attachment configured for use with a powered hammer to drive a rod into the ground, the attachment comprising:
a body;
an impact portion defining an impact axis, the impact portion including a bore configured to receive a drive shank that is coupled to the powered hammer, the impact portion configured to receive repeated impacts from the powered hammer;
a driving portion in which the rod is receivable, the driving portion configured to engage the rod and transmit a driving force due to impacts from the powered hammer to the rod; and
a retention device adjacent the bore of the impact portion, the retention device including a locking mechanism configured to secure the drive shank in the bore, the locking mechanism allowing axial movement of the drive shank within the bore along the impact axis.

10. The attachment of claim 9, wherein the drive shank defines a groove having a length measured parallel to the impact axis, and wherein the locking mechanism has dimension measured parallel to the impact axis, and wherein the dimension of the locking mechanism is less than the length of the groove.

11. The attachment of claim 9, wherein the locking mechanism is a fastener.

12. The attachment of claim 9, wherein the locking mechanism is a ball bearing or a dowel pin.

13. The attachment of claim 9, wherein the retention device further includes a sleeve that is moveable between a first position, in which the shank is secured within the bore, and a second position, in which the shank is removable from the bore.

14. The attachment of claim 13, wherein when in the first position, the sleeve forces the locking mechanism to engage the drive shank, and wherein when in the second position, the sleeve allows the locking mechanism to move away from a drive shaft.

15. An attachment configured for use with a powered hammer to drive a rod into the ground, the attachment comprising:
a body defining an aperture;
an impact portion defining an impact axis, the impact portion configured to receive repeated impacts from a drive shank of the powered hammer; and
a driving portion including
a one-way collet positioned at least partially within the aperture of the body and configured to transmit a driving force generated by the impacts from the powered hammer to the rod, the one-way collet defining a driving axis that is angled relative to the impact axis,
an end cap coupled to the body and extending over a portion of the aperture, and
a biasing member disposed between the collet and the end cap.

16. The attachment of claim 15, wherein the end cap is a threadedly coupled to the body.

17. The attachment of claim 16, wherein the driving portion also includes a fastener to secure the end cap within the aperture.

18. The attachment of claim 17, wherein the end cap includes a base that engages the biasing member and a sidewall that extends from the base and engages an inner surface of the body, and wherein the sidewall includes a flat that is engaged by the fastener.

19. The attachment of claim 17, wherein the end cap includes a base that engages the biasing member and a sidewall that extends from the base and engages an inner surface of the body, and wherein the sidewall defines a notch that receives the fastener.

20. The attachment of claim 15, wherein the aperture defines a groove and a plurality of cavities connected to the groove, and wherein the end cap includes a plate having a plurality of lobes received in the groove through the plurality of cavities.
